(19) United States
(12) Patent Application Publication
(10) Pub. No.: US 2008/0167006 A1
(43) Pub. Date: Jul. 10, 2008

(54) COMMUNICATION DEVICE

(75) Inventor: Chen-Ning Hsi, Taipei (TW)

Correspondence Address: MADSON & AUSTIN, 15 WEST SOUTH TEMPLE, SUITE 900, SALT LAKE CITY, UT, 84101, US

(73) Assignee: Primax Electronics Ltd., Taipei (TW)

(21) Appl. No.: 11/750,070

(22) Filed: May 17, 2007

(30) Foreign Application Priority Data
Jan. 5, 2007 (TW) 096100427

(51) Int. Cl. H04M 1/663

(52) U.S. Cl. 455/412.2

(57) ABSTRACT

A communication device includes a notifying unit and a mode-controlling unit. When an incoming message or call is received by the communication device, the notifying unit generates a first notification signal or a second notification signal. The mode-controlling unit continuously detects the motion or the surrounding condition of a user, and controls the notifying unit to generate one of the first notification signal and the second notification signal, wherein the first notification signal and the second notification signal have different intensity or frequency.

### FIELD OF THE INVENTION

The present invention relates to a communication device, and more particularly to a communication device including a mode-controlling unit for detecting the user's motion and/or the user's surrounding condition and a notifying unit for generating a notification signal.

### BACKGROUND OF THE INVENTION

In modern society, pagers, mobile phones and personal digital assistants (PDAs) become essential communication devices because they are portable. When such a communication device is used, the notification mode of the communication device has been previously determined according to the user's motion or the circumstance where the user is. In other words, if the notification mode is not adjusted as the user's motion or circumstance is changed, the possibility of causing missed message or missed call is increased. For example, in a case that the user takes a rest on a seat, it is favored to operate the communication device in a vibration notification mode. Whereas, in another case that the user is climbing stairs or running, it is favored to operate the communication device in a ring-tone notification mode. If the user's motion or the user's surrounding condition is changed, the possibility of causing missed message or missed call is increased. In a vibration notification mode, if the user's motion of taking a rest on a seat is changed to another motion of climbing stairs or running but the user forgets switching the vibration notification mode to the ring-tone notification mode or augmenting the intensity or the frequency of the ring tones, the possibility of causing missed message or missed call is increased because the user's body motion may interfere with the vibrating signals of the communication device. Even if the communication device is switched to the ring-tone notification mode, the intensity or the frequency of the ring tones should be augmented to facilitate the user to hear the ring tone. Similarly, if the user is moved from a quiet office to a noisy street but the user forgets switching the ring-tone notification mode to the vibration notification mode or augmenting the volume of the ring tones, the noisy background may either interfere with the vibrating signals of the communication device in the vibration notification mode or interfere with the ring tones of the communication device in the ring-tone notification mode. Consequently, the possibility of causing missed message or missed call is also increased.

As known, if the motion or the surrounding condition of the user is highly changeable, some sensory organs of the user may be occupied and in a busy state. Under this circumstance, the user often overuses the eyes, ears or skin. Due to the background interference, the notification signals generated from the communication device are often unrecognized. In addition, the notification modes and other settings of the communication device may be selected via a user operation interface. However, since the process of adjusting the notification modes and settings is manually done, such process is not user-friendly.

Moreover, the approaches of inputting commands into the communication device are diverse. For example, the user may input commands into the communication device by pressing one or more keys through a keyboard, writing through a handwriting plate, sounding through a microphone, or vibrating or knocking the main body of the communication device.

For a purpose of setting or changing the approach of inputting commands, the input mode of the communication device is firstly selected and then corresponding input device is activated. Consequently, the commands will be effectively transmitted to the command receiver of the communication device. For example, in the case of sitting in a rocking car and intending to edit a short message while using a mobile phone, the user may change the input mode of the communication device to a sound control mode and turn on a microphone to edit the short message by sound control.

Similarly, if the motion or the surrounding condition of the user is highly changeable, the input command may fail to be effectively transmitted to the command receiver of the communication device due to the background interference. However, since the processes of adjusting the input modes and activating corresponding input devices are manually done, these processes are also not user-friendly.

As previously described, the communication devices such as pages, mobile phones and personal digital assistants (PDAs) are principally used to inform the user that an incoming message or call is received. Therefore, there is a need of providing a communication device having a function of detecting the motion and/or the surrounding condition of the user and generating a notification signal which is easily sensed by the user wherever and whenever the user is. As a consequence, the possibility of causing missed message or missed call is minimized without frequently changing the settings of the communication device. In addition, there is also a need of providing a communication device capable of detecting the motion and/or the surrounding condition of the user and automatically enabling a command receiver to receive the input commands, thereby conveniently inputting commands into the communication device without the need of frequently switching the receiving approaches.

In views of the above-described disadvantages resulted from the prior art, the applicant keeps on carving unflaggingly to develop an improved communication device according to the present invention through wholehearted experience and research.

### SUMMARY OF THE INVENTION

It is an object of the present invention to provide a communication device having a function of detecting the motion and/or the surrounding condition of the user and generating a notification signal which is easily sensed by the user wherever and whenever the user is, thereby facilitating the user to read messages or answer calls.

Another object of the present invention to provide a communication device having a function of detecting the motion and/or the surrounding condition of the user and automatically enabling a suitable command receiver to receive the input commands according to the detecting results.

In accordance with an aspect of the present invention, there is provided a communication device. The communication device includes a signal receiver, a notifying unit and a mode-controlling unit. The signal receiver is used for receiving an incoming message or call from other communication devices. The mode-controlling unit continuously detects the motion or the surrounding condition of a user. When an incoming message or call is received by the signal receiver, the mode-controlling unit controls the notifying unit generates at least a notification signal which is easily sensed by the user, thereby facilitating the user to read the message or answer the call.

In accordance with another aspect of the present invention, there is provided a communication device. The communication device includes a command receiver and a mode-controlling unit. The command receiver may receive an input command issued from the user. The mode-controlling unit continuously detects the motion or the surrounding condition of a user, and enables the command receiver to receive the input command.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic architecture of a communication device according to a preferred embodiment of the present invention; and

FIG. 2 is a schematic flowchart illustrating the operation of the mode-controlling unit of the present communication device.

### DETAILED DESCRIPTION OF THE PREFERRED EMBODIMENT

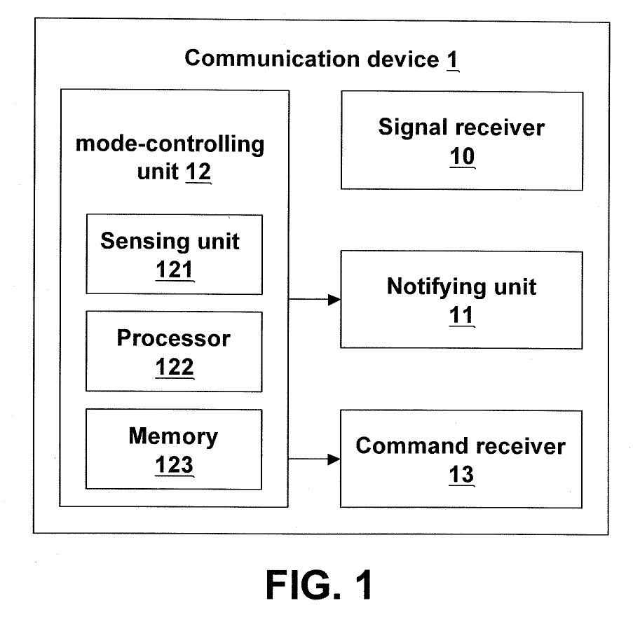

Referring to FIG. 1, a schematic architecture of a communication device according to a preferred embodiment of the present invention is illustrated. The communication device 1 principally includes a signal receiver 10, a notifying unit 11 and a mode-controlling unit 12. An exemplary signal receiver 10 includes but is not limited to a wireless signal receiver or an IR for receiving messages or incoming calls from other communication devices (not shown). An example of the notifying unit 11 is a vibrator, a speaker or a light-emitting element for respectively generating a vibrating notification signal, a ring-tone notification signal or a flashlight notification signal to notify the user that a message or an incoming call is being received.

Please refer to FIG. 1 again. The mode-controlling unit 12 of the communication device 1 has a function of detecting the motion and/or the surrounding condition of the user. Whenever a message or an incoming call is received by the signal receiver 10 of the communication device 1, the mode-controlling unit 12 will issue a notification signal to inform the user so as to minimize the missed call. In an embodiment, the notification signal is easily sensed by the user wherever and whenever the user is.

As shown in FIG. 1, the mode-controlling unit 12 principally includes a sensing unit 121, a processor 122 and a memory 123. An exemplary sensing unit 121 includes but is not limited to a vibration sensor, a sound sensor or an optical sensor for continuously detecting the vibration of the user's motion, the background sound level of the user's surrounding condition or the brightness level of the user's surrounding condition, respectively. A preset range or a preset value has been stored in the memory 123. By the processor 122, the detecting result from the sensing unit 121 is compared with the preset range (or the preset value) to discriminate whether the eyes, ears or skin of the user is in a busy state and fails to effectively sense the vibrating notification signal, the ring-tone notification signal or the flashlight notification signal.

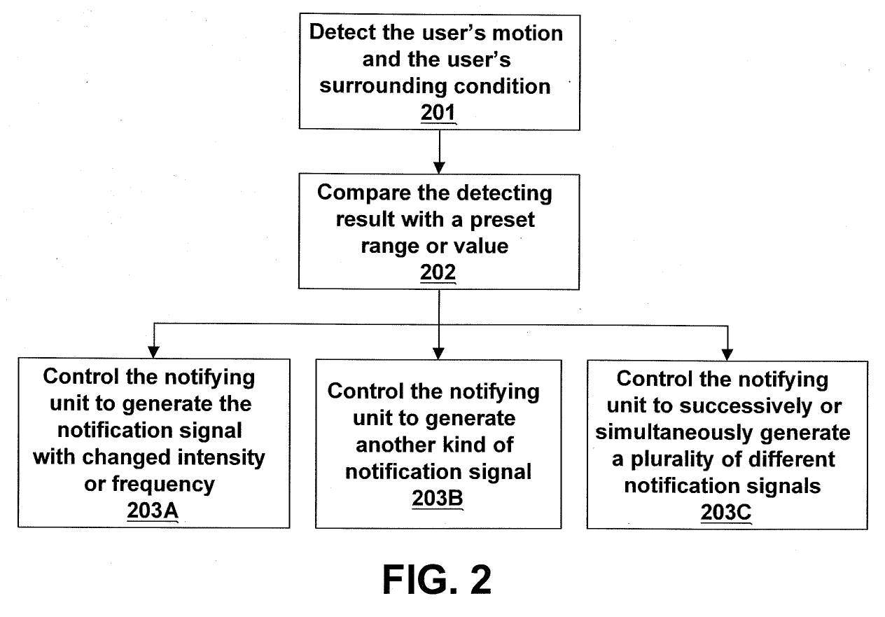

Hereinafter, the operation of the mode-controlling unit 12 will be illustrated with reference to the flowchart of FIG. 2.

First of all, in the Step 201, the sensing unit 121 of the mode-controlling unit 12, which has a sensing function corresponding a specified user's sensory organ, continuously detects the motion and the surrounding condition of the user. For example, a vibration sensor, a sound sensor or a light sensor are employed for continuously detecting the vibration of the user's motion, the background sound level of the user's surrounding condition or the brightness level of the user's surrounding condition, respectively.

Next, in the Step 202, the processor 122 of the mode-controlling unit 12 compares the detecting result of the sensing unit 121 with the preset range (or the preset value) stored in the memory 123, thereby discriminating whether either of the user's sensory organs such as eyes, ears or skin is in a busy state and fails to effectively function. The preset range (or the preset value) may be embedded into the memory 123 according to the manufacturer's design. Alternatively, the preset range (or the preset value) may be predetermined or changed according to the user's requirement. That is, when the user performs a specified motion or is under a specific surrounding condition, some physical quantities are detected by the sensing unit 121 to define the preset range or the preset value.

When an incoming message or call from other communication devices is received by the communication device 1, the processor 122 of the mode-controlling unit 12 will generate one or more easily cognitive notification signals in one of the following three approaches.

According to the first approach (step 203A), the mode-controlling unit 12 may control the intensity or frequency of the notification signal emitted from the notifying unit 11. As a consequence, even if the eyes, ears or skin of the user is in a busy state, the notification signal with adjusted intensity or frequency may be sensed by the user.

According to the second approach (step 203B), the mode-controlling unit 12 may control the notifying unit 11 to generate another kind of notification signal. As a consequence, even if one sensory organ is occupied, another sensory organ may effectively sense another kind of notification signal.

According to the third approach (step 203C), the mode-controlling unit 12 may control the notifying unit 11 to successively or simultaneously generate a plurality of different notification signals. As a consequence, plural sensory organs of the user may successively or simultaneously sense plural notification signals and the probability of sensing the notification signals by the user is enhanced.

In the communication device 1 of the present invention, the mode-controlling unit 12 includes one or more sensors 121. Correspondingly, the processor 122 of the mode-controlling unit 12 may control one or more notifying unit 11 to generate one or more notification signals.

Hereinafter, some embodiments of the communication device 1 of the present invention will be illustrated as follows with reference to FIGS. 1 and 2.

In a first embodiment, the communication device 1 includes a signal receiver 10, a notifying unit 11 and a mode-controlling unit 12. The notifying unit 11 includes a vibrator for generating a vibrating notification signal. The sensing unit 121 of the mode-controlling unit 12 includes a vibration sensor for continuously detecting the vibration amount of the user's motion. For example, the vibration amount detected when the user takes a rest in a seat may be defined as a preset value or a preset range. The preset value or preset range may be stored into the memory 123 either according to the manufacturer's design or predetermined or changed according to the user's requirement. If the vibration amount detected when the user walks is greater than the preset value or preset range, the mode-controlling unit 12 will control the vibrator 11 to generate a vibration notification signal having increased intensity or frequency. In contrast, in a case that the communication device 1 is placed on a desk or the user sits still, the vibration amount continuously detected by the vibration sensor 12 is below the preset value or preset range. As a consequence, the mode-controlling unit 12 will control the vibrator 11 to generate a vibration notification signal having lower intensity or frequency. Under this circumstance, this lower-intensity or lower-frequency vibration notification signal may be effectively sensed by the user.

In a second embodiment, the communication device 1 includes a signal receiver 10, a notifying unit 11 and a mode-controlling unit 12. The notifying unit 11 includes a speaker for generating a ring-tone notification signal. The sensing unit 121 of the mode-controlling unit 12 includes a sound sensor for continuously detecting the sound level of the user's surrounding condition. For example, the sound level detected when the user is in an office may be defined as a preset value or a preset range. The preset value or preset range may be stored into the memory 123 either according to the manufacturer's design or predetermined or changed according to the user's requirement. If the sound level detected when the user is in a noisy outdoor surrounding condition is greater than the preset value or preset range, the mode-controlling unit 12 will control the speaker 11 to generate a ring-tone notification signal having increased intensity or volume when an incoming message or call is received. In contrast, when the user enters a quiet place (e.g. a conference room), the sound level continuously detected by the sound sensor 12 will be below the preset value or preset range. As a consequence, the mode-controlling unit 12 will control the speaker 11 to generate a ring-tone notification signal having lower intensity or volume.

In a third embodiment, the communication device 1 includes a signal receiver 10, a notifying unit 11 and a mode-controlling unit 12. The notifying unit 11 includes a light-emitting element for generating a flashlight notification signal. The sensing unit 121 of the mode-controlling unit 12 includes an optical sensor for continuously detecting the brightness level of the user's surrounding condition. For example, the brightness level detected when the user is in an office may be defined as a preset value or a preset range. The preset value or preset range may be stored into the memory 123 either according to the manufacturer's design or predetermined or changed according to the user's requirement. If the brightness level detected when the user is in a darker surrounding condition (e.g. in a lecture hall) is less than the preset value or preset range, the mode-controlling unit 12 will control the light-emitting element 11 to generate a flashlight notification signal having increased brightness level or flash frequency when an incoming message or call is received.

In a fourth embodiment, the communication device 1 includes a signal receiver 10, a notifying unit 11 and a mode-controlling unit 12. The notifying unit 11 includes a vibrator and a speaker for generating a vibrating notification signal and a ring-tone notification signal, respectively. The sensing unit 121 of the mode-controlling unit 12 includes a vibration sensor for continuously detecting the vibration amount of the user's motion. For example, the vibration amount detected when the user takes a rest in a seat may be defined as a preset value or a preset range. The preset value or preset range may be stored into the memory 123 either according to the manufacturer's design or predetermined or changed according to the user's requirement. If the vibration amount detected when the user walks is greater than the preset value or preset range, the mode-controlling unit 12 will control the speaker to generate a ring-tone notification signal in response to receipt of the incoming message or call.

In a fifth embodiment, the communication device 1 includes a signal receiver 10, a notifying unit 11 and a mode-controlling unit 12. The notifying unit 11 includes a vibrator and a light-emitting element for generating a vibrating notification signal and a flashlight notification signal, respectively. The sensing unit 121 of the mode-controlling unit 12 includes a vibration sensor for continuously detecting the vibration amount of the user's motion. For example, the vibration amount detected when the user takes a rest in a seat may be defined as a preset value or a preset range. The preset value or preset range may be stored into the memory 123 either according to the manufacturer's design or predetermined or changed according to the user's requirement. If the communication device 1 is placed on a desk or the user sits still and the vibration amount continuously detected by the vibration sensor 12 is below the preset value or preset range, the mode-controlling unit 12 will control the light-emitting element to generate a flashlight notification signal in response to receipt of the incoming message or call.

In a sixth embodiment, the communication device 1 includes a signal receiver 10, a notifying unit 11 and a mode-controlling unit 12. The notifying unit 11 includes a speaker and a vibrator for generating a vibrating notification signal and a vibration notification signal, respectively. The sensing unit 121 of the mode-controlling unit 12 includes a sound sensor for continuously detecting the sound level of the user's surrounding condition. For example, the sound level detected when the user is in an office may be defined as a preset value or a preset range. The preset value or preset range may be stored into the memory 123 either according to the manufacturer's design or predetermined or changed according to the user's requirement. If the sound level detected when the user is in a noisy outdoor surrounding condition is greater than the preset value or preset range, the mode-controlling unit 12 will control the vibrator to generate a vibration notification signal when an incoming message or call is received. Likewise, if the sound level detected when the user is in a quiet place (e.g. a conference room) is below the preset value or preset range, the mode-controlling unit 12 may also control the vibrator to generate a vibration notification signal when an incoming message or call is received.

In a seventh embodiment, the communication device 1 includes a signal receiver 10, a notifying unit 11 and a mode-controlling unit 12. The notifying unit 11 includes a speaker and a light-emitting element for generating a ring-tone notification signal and a flashlight notification signal, respectively. The sensing unit 121 of the mode-controlling unit 12 includes a sound sensor for continuously detecting the sound level of the user's surrounding condition. For example, the sound level detected when the user is in an office may be defined as a preset value or a preset range. The preset value or preset range may be stored into the memory 123 either according to the manufacturer's design or predetermined or changed according to the user's requirement. If the sound level detected when the user is in a noisy outdoor surrounding condition is greater than the preset value or preset range, the mode-controlling unit 12 will control the light-emitting element to generate a flashlight notification signal when an incoming message or call is received. Likewise, if the sound level detected when the user is in a quiet place (e.g. a conference room) is below the preset value or preset range, the mode-controlling unit 12 will also control the light-emitting element to generate a flashlight notification signal when an incoming message or call is received.

In an eighth embodiment, the communication device 1 includes a signal receiver 10, a notifying unit 11 and a mode-controlling unit 12. The notifying unit 11 includes a light-emitting element and a speaker for generating a flashlight notification signal and a ring-tone notification signal, respectively. The sensing unit 121 of the mode-controlling unit 12 includes an optical sensor for continuously detecting the flashlight notification signal of the user's surrounding condition. For example, the brightness level detected when the user is in an office may be defined as a preset value or a preset range. The preset value or preset range may be stored into the memory 123 either according to the manufacturer's design or predetermined or changed according to the user's requirement. If the brightness level detected when the user is in a brighter surrounding condition (e.g. in a sunny outdoors) is greater than the preset value or preset range, the mode-controlling unit 12 will control the speaker to generate a ring-tone notification signal when an incoming message or call is received. Likewise, if the brightness level detected when the user is in a brighter surrounding condition (e.g. in a lecture hall) is below the preset value or preset range, the mode-controlling unit 12 will control the speaker to generate a ring-tone notification signal when an incoming message or call is received.

In a ninth embodiment, the communication device 1 includes a signal receiver 10, a notifying unit 11 and a mode-controlling unit 12. The notifying unit 11 includes a light-emitting element and a vibrator for generating a flashlight notification signal and a vibration notification signal, respectively. The sensing unit 121 of the mode-controlling unit 12 includes an optical sensor for continuously detecting the flashlight notification signal of the user's surrounding condition. For example, the brightness level detected when the user is in an office may be defined as a preset value or a preset range. The preset value or preset range may be stored into the memory 123 either according to the manufacturer's design or predetermined or changed according to the user's requirement. If the brightness level detected when the user is in a brighter surrounding condition (e.g. in a sunny outdoors) is greater than the preset value or preset range, the mode-controlling unit 12 will control the vibrator to generate a vibration notification signal when an incoming message or call is received. Likewise. If the brightness level detected when the user is in a darker surrounding condition (e.g. in a lecture hall) is below the preset value or preset range, the mode-controlling unit 12 will control the vibrator to generate a vibration notification signal when an incoming message or call is received.

From the above embodiments, the mode-controlling unit 12 may control a suitable notifier of the notifying unit 11 to generate an easily cognitive notification signal according to the detecting result of the sensing unit 121.

Moreover, the mode-controlling unit 12 may control the notifying unit 11 to successively or synchronously generate at least two different notification signals. For example, except that a vibrator and a light-emitting element for respectively generating a vibrating notification signal and a flashlight notification signal are included in the notifying unit 11 of the fifth embodiment, the notifying unit 11 may further include a speaker for generating a ring-tone notification signal. When an incoming message or call is received by the signal receiver 10, the mode-controlling unit 12 may control the light-emitting element to generate a flashlight notification signal or simultaneously or successively generate a ring-tone notification signal. As a consequence, the probability of sensing the notification signals by the user is enhanced.

From the above embodiments, the mode-controlling unit 12 of the communication device 1 comprises one sensor in the sensing unit 121 and at least one notifier in the notifying unit 11. Moreover, the mode-controlling unit 12 of the communication device 1 could further comprise a plurality of sensors in the sensing unit 121 and a plurality of notifiers in the notifying unit 11. When an incoming message or call is received by the signal receiver 10, the processor 122 of the mode-controlling unit 12 may evaluate the detecting results of the sensors in the sensing unit 121. Afterwards, the processor 122 may select a most proper notifier to generate the corresponding notification signal, or select several notifiers to simultaneously or successively generate several notification signals. For example, the sensing unit 121 of the mode-controlling unit 12 includes an optical sensor, a sound sensor and a vibration sensor. In addition, the notifying unit 11 includes a light-emitting element, a speaker and a vibrator for generating a flashlight notification signal, a ring-tone notification signal and a vibrating notification signal, respectively. For example, when the user is in a dark and quiet surrounding condition, the brightness level detected by the optical sensor is below a first preset value or preset range, the sound level detected by the sound sensor is below a second preset value or preset range and the vibration amount detected by the vibration sensor is below a third preset value or preset range. Under this circumstance, when an incoming message or call is received by the signal receiver 10, the mode-controlling unit 12 may successively control the vibration sensor to generate a vibration notification signal, the light-emitting element to generate a flashlight notification signal and the speaker to generate a ring-tone notification signal. Since multiple sensors are cooperated to detect the user's motion and the user's surrounding condition, the probability of sensing the notification signals by the user is enhanced.

Please refer to the schematic architecture of FIG. 1 again. As previously described, since the user's motions or the user's surrounding conditions are highly changeable, the approaches of inputting the commands into the communication device 1 are frequently changed. For a purpose of effectively inputting the commands into the communication device 1 to comply with different motions or surrounding conditions of the user, the mode-controlling unit 12 of the present invention may continuously detect the user's motions or the user's surrounding conditions and then select a suitable approach for the user to create the commands. In addition, the command receiver 13 of the communication device 1 is automatically enabled to receive the commands. The example of the command receiver 13 used in the present invention includes an analog-to-digital converter such as a microphone.

In a tenth embodiment of the present invention, the communication device 1 includes a mode-controlling unit 12 and a command receiver 13. The sensing unit 121 of the mode-controlling unit 12 includes an optical sensor for continuously detecting the flashlight notification signal of the user's surrounding condition. The command receiver 13 includes for example a function key depressed to input commands and a microphone for receiving sound control commands therevia. For example, the brightness level detected when the user is in an office may be defined as a preset range. The preset range may be stored into the memory 123 either according to the manufacturer's design or predetermined or changed according to the user's requirement. As known, when the user is in a brighter surrounding condition (e.g. in a sunny outdoors) or when the user is in a darker surrounding condition (e.g. in a lecture hall or on a dark street), the brightness level detected by the optical sensor is beyond the preset range. Since the screen of the communication device 1 fails to clearly viewed when the brightness level is beyond (over or below) the preset range, it is difficult to input commands by pressing the function key through a keyboard or writing through a handwriting plate. Under these circumstances, the microphone of the communication device 1 will be automatically enabled to receive the sound control commands.

The communication device 1 according to the eleventh embodiment of the present invention includes a mode-controlling unit 12 and a command receiver 13. The sensing unit 121 of the mode-controlling unit 12 includes a vibration sensor for continuously detecting the vibration notification signal of the user's motion. The command receiver 13 includes for example a function key depressed to input commands and a microphone for receiving sound control commands therevia. For example, the vibration amount detected when the user takes a rest in a seat may be defined as a preset value or a preset range. The preset value or preset range may be stored into the memory 123 either according to the manufacturer's design or predetermined or changed according to the user's requirement. As known, the vibration amount detected when the user walks is usually over the preset value or preset range. Due to the vigorous body motion of the user, it is difficult to input commands by pressing the function key through a keyboard or writing through a handwriting plate. Under these circumstances, the microphone of the communication device 1 will be automatically enabled to receive the sound control commands.

Moreover, the communication device 1 of the present invention may be switched in different operating modes according to the sensors in the sensing unit. For example, the communication device 1 may further include a touch sensor. When the touch sensor is contacted, the communication device 1 is switched between a call-receiving mode and a photographing mode.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A communication device comprising:
a notifying unit for generating a first notification signal or a second notification signal when an incoming message or call is received by said communication device; and
a mode-controlling unit for continuously detecting the motion or the surrounding condition of a user, and controlling said notifying unit to generate one of said first notification signal and said second notification signal, wherein said first notification signal and said second notification signal have different intensity or frequency.

2. The communication device according to claim 1 wherein said notifying unit includes a vibrator for generating a first vibration notification signal or a second vibration notification signal, the intensity or frequency of said second vibration notification signal being greater than that of said first vibration notification signal, and said mode-controlling unit includes a vibration sensor for detecting a vibration amount of the user's motion, wherein said mode-controlling unit controls said vibrator to generate said second vibration notification signal when said vibration amount is over a preset range or value.

3. The communication device according to claim 1 wherein said notifying unit includes a vibrator for generating a first vibration notification signal or a second vibration notification signal, the intensity or frequency of said second vibration notification signal being lower than that of said first vibration notification signal, and said mode-controlling unit includes a vibration sensor for detecting a vibration amount of the user's motion, wherein said mode-controlling unit controls said vibrator to generate said second vibration notification signal when said vibration amount is blow a preset range or value.

4. The communication device according to claim 1 wherein said notifying unit includes a speaker for generating a first ring-tone notification signal or a second ring-tone notification signal, the intensity or volume of said second ring-tone notification signal being greater than that of said first ring-tone notification signal, and said mode-controlling unit includes a sound sensor for detecting a sound level of the user's surrounding condition, wherein said mode-controlling unit controls said sound sensor to generate said second ring-tone notification signal when said sound level is over a preset range or value.

5. The communication device according to claim 1 wherein said notifying unit includes a speaker for generating a first ring-tone notification signal or a second ring-tone notification signal, the intensity or volume of said second ring-tone notification signal being lower than that of said first ring-tone notification signal, and said mode-controlling unit includes a sound sensor for detecting a sound level of the user's surrounding condition, wherein said mode-controlling unit controls said sound sensor to generate said second ring-tone notification signal when said sound level is below a preset range or value.

6. The communication device according to claim 1 wherein said notifying unit includes a light-emitting element for generating a first flashlight notification signal or a second flashlight notification signal, the intensity of said second flashlight notification signal being greater than that of said first flashlight notification signal, and said mode-controlling unit includes an optical sensor for detecting a brightness level of the user's surrounding condition, wherein said mode-controlling unit controls said optical sensor to generate said second flashlight notification signal when said brightness level is below a preset range or value.

7. The communication device according to claim 1 wherein said notifying unit includes a light-emitting element for generating a first flashlight notification signal or a second flashlight notification signal, the flash frequency of said second flashlight notification signal being greater than that of said first flashlight notification signal, and said mode-controlling unit includes an optical sensor for detecting a brightness level of the user's surrounding condition, wherein said mode-controlling unit controls said optical sensor to generate said second flashlight notification signal when said brightness level is below a preset range or value.

8. A communication device comprising:
a first notifier for generating a first notification signal when an incoming message or call is received by said communication device;
a second notifier for generating a second notification signal when an incoming message or call is received by said communication device; and
a mode-controlling unit for continuously detecting the motion or the surrounding condition of a user, and controlling one of said first notifier and said second notifier to generate said first or second notification signal.

9. The communication device according to claim 8 wherein said first notifier is a vibrator for generating a vibration notification signal, said second notifier is a speaker for generating a ring-tone notification signal, and said mode-controlling unit includes a vibration sensor for detecting a vibration amount of the user's motion, wherein said mode-controlling unit controls said speaker to generate said ring-tone notification signal when said vibration amount is over a preset range or value.

10. The communication device according to claim 8 wherein said first notifier is a vibrator for generating a vibration notification signal, said second notifier is a light-emitting element for generating a flashlight notification signal, and said mode-controlling unit includes a vibration sensor for detecting a vibration amount of the user's motion, wherein said mode-controlling unit controls said light-emitting element to generate said flashlight notification signal when said vibration amount is below a preset range or value.

11. The communication device according to claim 8 wherein said first notifier is a speaker for generating a ring-tone notification signal, said second notifier is a vibrator for generating a vibration notification signal, and said mode-controlling unit includes a sound sensor for detecting a sound level of the user's surrounding condition, wherein said mode-controlling unit controls said vibrator to generate said vibration signal when said sound level is over a preset range or value.

12. The communication device according to claim 8 wherein said first notifier is a speaker for generating a ring-tone notification signal, said second notifier is a vibrator for generating a vibration notification signal, and said mode-controlling unit includes a sound sensor for detecting a sound level of the user's surrounding condition, wherein said mode-controlling unit controls said vibrator to generate said vibration signal when said sound level is below a preset range or value.

13. The communication device according to claim 8 wherein said first notifier is a speaker for generating a ring-tone notification signal, said second notifier is a light-emitting element for generating a flashlight notification signal, and said mode-controlling unit includes a sound sensor for detecting a sound level of the user's surrounding condition, wherein said mode-controlling unit controls said light-emitting element to generate said flashlight signal when said sound level is over a preset range or value.

14. The communication device according to claim 8 wherein said first notifier is a speaker for generating a ring-tone notification signal, said second notifier is a light-emitting element for generating a flashlight notification signal, and said mode-controlling unit includes a sound sensor for detecting a sound level of the user's surrounding condition, wherein said mode-controlling unit controls said light-emitting element to generate said flashlight signal when said sound level is below a preset range or value.

15. The communication device according to claim 8 wherein said first notifier is a light-emitting element for generating a flashlight notification signal, said second notifier is a speaker for generating a ring-tone notification signal, and said mode-controlling unit includes an optical sensor for detecting a brightness level of the user's surrounding condition, wherein said mode-controlling unit controls said speaker to generate said ring-tone notification signal when said brightness level is over a preset range or value.

16. The communication device according to claim 8 wherein said first notifier is a light-emitting element for generating a flashlight notification signal, said second notifier is a speaker for generating a ring-tone notification signal, and said mode-controlling unit includes an optical sensor for detecting a brightness level of the user's surrounding condition, wherein said mode-controlling unit controls said speaker to generate said ring-tone notification signal when said brightness level is below a preset range or value.

17. The communication device according to claim 8 wherein said first notifier is a light-emitting element for generating a flashlight notification signal, said second notifier is a vibrator for generating a vibration notification signal, and said mode-controlling unit includes an optical sensor for detecting a brightness level of the user's surrounding condition, wherein said mode-controlling unit controls said vibrator to generate said vibration notification signal when said brightness level is over a preset range or value.

18. The communication device according to claim 8 wherein said first notifier is a light-emitting element for generating a flashlight notification signal, said second notifier is a vibrator for generating a vibration notification signal, and said mode-controlling unit includes an optical sensor for detecting a brightness level of the user's surrounding condition, wherein said mode-controlling unit controls said vibrator to generate said vibration notification signal when said brightness level is below a preset range or value.

19. A communication device comprising:
a first command receiver for receiving a first input command;
a second command receiver for receiving a second input command; and
a mode-controlling unit for continuously detecting the motion or the surrounding condition of a user, and enabling one of said first command receiver and said second command receiver to receive said first input command and said second input command.

20. The communication device according to claim 19 wherein said first command receiver is a function key, said second command receiver is a microphone, and said mode-controlling unit includes an optical sensor for detecting a brightness level of the user's surrounding condition, wherein said mode-controlling unit enables said microphone when said brightness level is over a preset range or value.

21. The communication device according to claim 19 wherein said first command receiver is a function key, said second command receiver is a microphone, and said mode-controlling unit includes an optical sensor for detecting a brightness level of the user's surrounding condition, wherein said mode-controlling unit enables said microphone when said brightness level is below a preset range or value.

22. The communication device according to claim 19 wherein said first command receiver is a function key, said second command receiver is a microphone, and said mode-controlling unit includes a vibration sensor for detecting a vibration amount of the user's motion, wherein said mode-controlling unit enables said microphone when said vibration amount is over a preset range or value.
